(19) United States
(12) Patent Application Publication
(10) Pub. No.: US 2007/0000305 A1
(43) Pub. Date: Jan. 4, 2007

(54) Gas phase chemical sensor based on film bulk resonators (FBAR)

(76) Inventors: Qing Ma, San Jose, CA (US); Li-Peng Wang, San Jose, CA (US); Valluri Rao, Saratoga, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/174,059

(22) Filed: Jun. 30, 2005

(51) Int. Cl. G01N 29/02

(52) U.S. Cl. 73/24.01

(57) ABSTRACT

An FBAR device may be chemically functionalized by depositing an interactive layer so that targeted chemicals are preferentially adsorbed. Such miniaturized chemical sensors may be combined with wireless network technology. For example, a chemical sensor may be integrated in a cell phone, PDA, a watch, or a car with wireless connection and GPS. Since such devices are widely populated, a national sensor network may be established. Consequently, a national toxicity map can be generated in real time. Detailed chemical information may be obtained, such as if a chemical is released by a source fixed on ground or by a moving object, or if is spread by explosives or by wind and so on.

### FIELD OF THE INVENTION

Embodiments of the present invention relate to film bulk acoustic resonators (FBARs) and, more particularly to such devices used as chemical sensors.

### BACKGROUND INFORMATION

Film bulk acoustic resonator (FBAR) technology may be used as a basis for forming many of the frequency components in modern wireless systems. For example, FBAR technology may be used to form filter devices, oscillators, resonators, and a host of other frequency related components. FBAR may have advantages compared to other resonator technologies, such as Surface Acoustic Wave (SAW) and traditional crystal oscillator technologies. In particular, unlike crystals oscillators, FBAR devices may be integrated on a chip and typically have better power handling characteristics than SAW devices.

The descriptive name given to the technology, FBAR, may be useful to describe its general principals. In short, “Film” refers to a thin piezoelectric film such as Aluminum Nitride (AlN) sandwiched between two electrodes. Piezoelectric films have the property of mechanically vibrating in the presence of an electric field as well as producing an electric field if mechanically vibrated. “Bulk acoustic” refers to the acoustic wave generated within the bulk of the films stack. As opposed to the SAW device, the acoustic wave is on the surface of the piezoelectric substrate (or film).

### BRIEF DESCRIPTION OF THE DRAWINGS

FIG. 1 is a side view of a free-standing membrane film bulk acoustic resonator (FBAR);

FIG. 2 is a side view of a solidly mounted membrane film bulk acoustic resonator (FBAR);

FIG. 3 is a view illustrating the operation of an FBAR;

FIG. 4 is a simple oscillator circuit using an FBAR;

FIG. 5 is a cut-away side view of an FBAR coated with an interactive layer so that targeted chemicals are preferentially adsorbed;

FIG. 6 is a cut-away side view of the FBAR shown in FIG. 5 after a targeted chemical is present with the interactive layer;

FIG. 7 is a diagram showing an embodiment of the invention of readout electronics of using two FBARs to get the comparative signal. using FBARs as miniature chemical detectors for example;

FIG. 8 is a diagram showing yet another embodiment of the invention using FBARs as miniature chemical detectors;

FIG. 9 is a diagram showing yet another embodiment of the invention using FBARs as miniature chemical detectors; and

FIG. 10 is an example of a toxicity map for a geographic region according to an embodiment of the invention.

### DETAILED DESCRIPTION

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiment.

A free-standing FBAR device 10 is schematically shown in FIG. 1. The FBAR device 10 may be formed on the horizontal plane of a substrate 12, such as silicon and may include an SiO₂ layer 13. A first layer of metal 14 is placed on the substrate 12, and then a piezoelectric layer 16 is placed onto the metal layer 14. The piezoelectric layer 16 may be Zinc Oxide (ZnO), Aluminum Nitride (AlN), Lead Zirconate Titanate (PZT), or any other piezoelectric material. A second layer of metal 18 is placed over the piezoelectric layer 14. The first metal layer 14 serves as a first electrode 14 and the second metal layer 18 serves as a second electrode 18. The first electrode 14, the piezoelectric layer 16, and the second electrode 18 form a stack 20. As shown, the stack may be, for example, around 1.8 μm thick. A portion of the substrate 12 behind or beneath the stack 20 may be removed using back side bulk silicon etching to form an opening 22. The back side bulk silicon etching may be done using deep trench reactive ion etching or using a crystallographic-orientation-dependent etch, such as Potassium Hydroxide (KOH), Tetra-Methyl Ammonium Hydroxide (TMAH), and Ethylene-Diamene Pyrocatechol (EDP).

The resulting structure is a horizontally positioned piezoelectric layer 16 sandwiched between the first electrode 14 and the second electrode 16 positioned above the opening 22 in the substrate 12. In short, the FBAR 10 comprises a membrane device suspended over an opening 22 in a horizontal substrate 12.

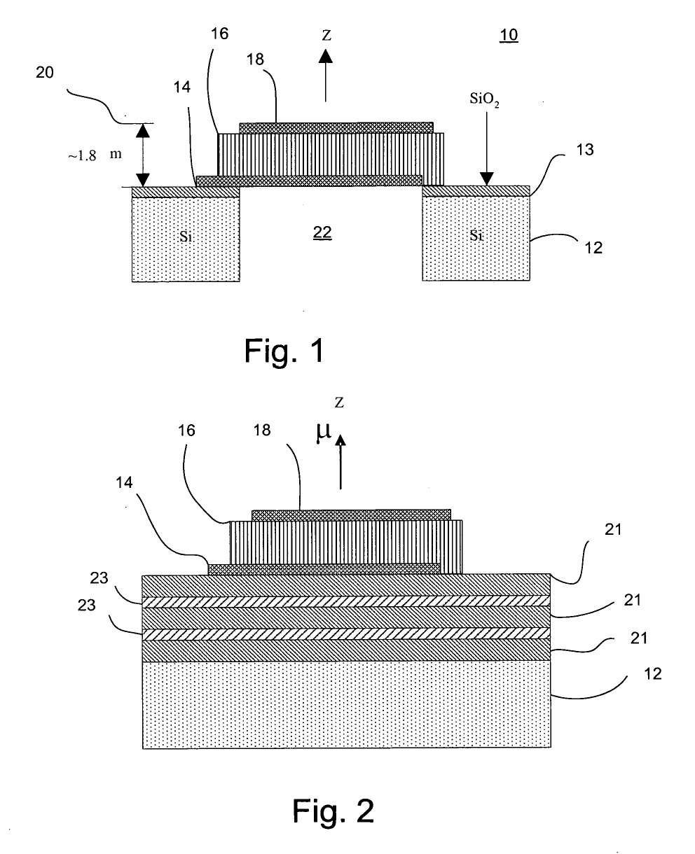

FIG. 2 shows yet another embodiment FBAR device comprising a solidly mounted membrane FBAR. In this case, the substrate 12 comprises a multilayer periodic structure, such as alternating layers of SiO₂ 21 and Tungsten (W) 23. Similar to above, a first layer of metal 14 is placed on the upper SiO₂ layer 21, and then a piezoelectric layer 16 is placed onto the metal layer 14. The piezoelectric layer 16 may be Zinc Oxide (ZnO), Aluminum Nitride (AlN), Lead Zirconate Titanate (PZT), or any other piezoelectric material. A second layer of metal 18 is placed over the piezoelectric layer 14. Again, the first metal layer 14 serves as a first electrode 14 and the second metal layer 18 serves as a second electrode 18. The alternating layers, 21 and 23, of the periodic structure reflects acoustic waves in the Z direction so that the acoustic wave is efficiently trapped in the solidly mounted membrane at the FBAR resonant frequency.

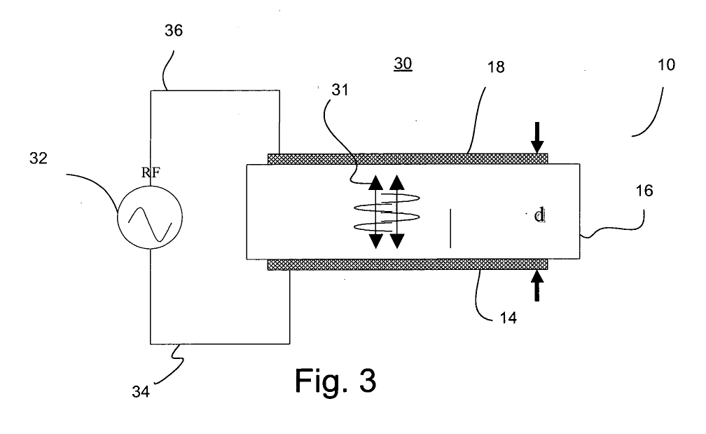

FIG. 3 illustrates the schematic of an electrical circuit 30 which includes a film bulk acoustic resonator 10. The electrical circuit 30 includes a source of radio frequency “RF” voltage 32. The source of RF voltage 32 is attached to the first electrode 14 via electrical path 34 and attached to the second electrode 18 by the second electrical path 36. The entire stack can freely resonate in the Z direction 31 when an RF voltage 32 at resonant frequency is applied. The resonant frequency is determined by the thickness of the membrane or the thickness of the piezoelectric layer 16 which is designated by the letter “d” or dimension “d” in FIG. 3. The resonant frequency is determined by the following formula:
f₀≈V/2d, where

f₀=the resonant frequency,

V=acoustic velocity of piezoelectric layer, and

d=the thickness of the piezoelectric layer.

It should be noted that the structure described in FIGS. 1-3 can be used either as a resonator or as a filter. To form an FBAR, piezoelectric films 16, such as ZnO, PZT and AlN, may be used as the active materials. The material properties of these films, such as the longitudinal piezoelectric coefficient and acoustic loss coefficient, are parameters for the resonator's performance. Performance factors include Q-factors, insertion loss, and the electrical/mechanical coupling. To manufacture an FBAR the piezoelectric film 16 may be deposited on a metal electrode 14 using for example reactive sputtering. The resulting films are polycrystalline with a c-axis texture orientation. In other words, the c-axis is perpendicular to the substrate.

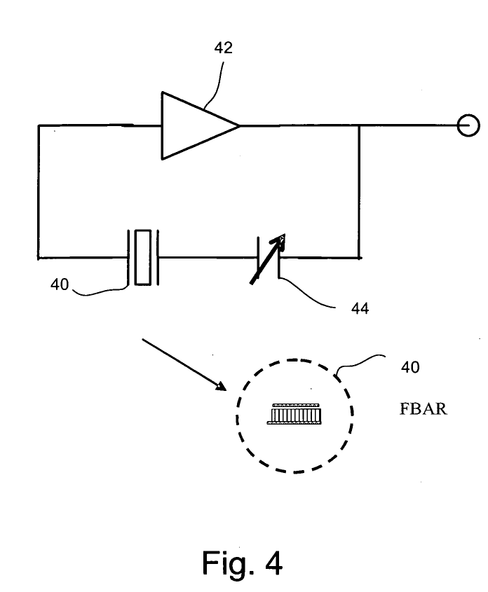

FIG. 4 is a simple circuit illustrating how an FBAR 40 may be used as a phase control element in a feedback loop of an oscillator circuit. As shown, the circuit comprises an amplifier 42 and a feedback loop including an FBAR 40 and an optional element such as a varactor 44.

Oscillation involves two conditions at the oscillation frequency. First, the closed loop phase shift should be 2 np, where p is the phase and n is an integer. The loop gain should be greater than or equal to unity. The stability of the oscillator is determined by that of the loop phase delay. Further, the frequency characteristics of the FBAR 40 tend to be influenced by temperature which may be undesirable for wireless communication applications. For example, for cell phone applications, the operation temperature specification may be between −35 and +85° C. Such extreme temperature variations may be encountered for example in a closed automobile where a cell phone may be kept. Because of temperature induced frequency drift, pass band windows are typically designed appreciably larger than they otherwise would be and transition bands sharper. Such design constraints tend to degrade insertion loss and demand more stringent processing requirements leading to reduced production yield.

According to embodiments of the invention, the surface of the FBAR 40 may be chemically functionalized by depositing an interactive layer so that targeted chemicals are preferentially adsorbed. When a chemical specie is adsorbed, the resonance frequency decreases due to mass loading effect. Sensitivity of FBAR with respect to absorbed chemicals may be very high. Miniaturized chemical sensors such as those described may be combined with wireless network technology. For example, a chemical sensor may be integrated in a cell phone, PDA, a watch, or a car with wireless connection and GPS. Since such devices are widely populated, a national sensor network may be established. Consequently, a national toxicity map can be generated in real time. Detailed chemical information may be obtained, such as if a chemical is released by a source fixed on ground or by a moving object, or if is spread by explosives or by wind and so on.

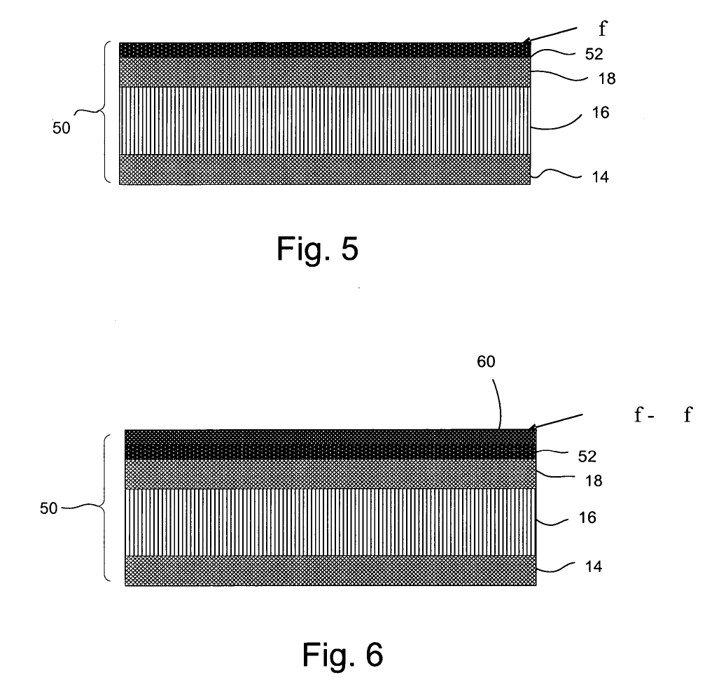

FIG. 5 shows a cut-away side view of the FBAR stack previously described comprising the lower electrode 14 and upper electrode 18 sandwiching the piezoelectric layer 14. Atop the upper electrode 18 an interactive layer 50 is placed. The interactive layer 50 is selected such that targeted chemicals are preferentially absorbed or collected. Once assembled, the FBAR will have a resonant frequency (f).

FIG. 6 shows the same stack as in FIG. 5 including electrodes 14 and 18, and piezoelectric layer 16 with a targeted chemical 60 absorbed or collected from the atmosphere associated with the interactive layer 50. This will tend to decrease the resonant frequency of the FBAR by Δf.

Different materials may comprise the interactive layer to target specific chemicals desired to be detected in the atmosphere. In general, the synthesis or selection of a perfectly selective coating for each analyte of interest (target chemical vapor) may be difficult, particularly if large numbers of chemicals are involved. Thus, each detector may have a different sensitive coated films. In combination with cluster analysis-based pattern recognition of the responses, a unique signature for each of mixed gases may be recognized. This is demonstrated for example in M. K. Bailer et al., A Cantilever Array-Based Artificial Nose, Ultrmicroscopy 82 (2000) 1-9.

As previously noted, when temperature changes, the resonance frequency of a FBAR changes correspondingly. This temperature drift should be taken account of in order to have accurate chemical detection.

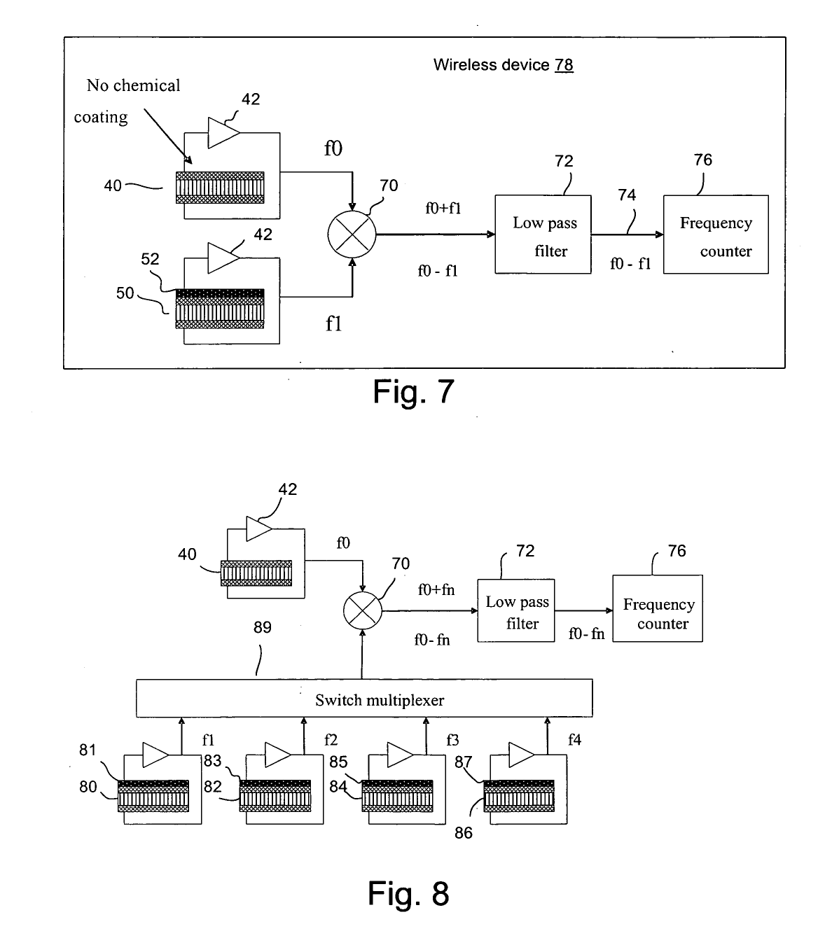

As shown in FIG. 7, two identical FBAR resonators, 40 and 50, may be placed side by side, but only one of the resonators 50 includes the chemically interactive layer 52 leaving the other resonator 40 as a reference, so the differential frequency change gives the chemical detection signal. This differential measurement technique may also be effective in improving yield. This is because there may be resonance frequency variations of FBAR across the wafer during manufacture and from wafer to wafer due to film thickness variations. By measuring differential frequency change, these processing variations may be canceled out. The outputs, f0 and f1, of the resonators 40 and 50 are combined at combiner 70 and passed through a low pass filter 72 to produce a differential output signal 74. A frequency counter 76 counts the differential frequency signal 74. A change in frequency may be used to determine that a targeted chemical is present and has been absorbed by the interactive layer 52.

The circuit shown in FIG. 7 may be part of a wireless device 78 such as a cell phone, PDA, or the like. With such wireless devices widely distributed by consumers over a large geographic region data collected from many such devices may be used to monitor chemicals in the air. Consequently, a national or regional toxicity map may be generated in real time. Detailed chemical information can be obtained, such as if a chemical is released by a source fixed on ground or by a moving object, or if is spread by explosives or by wind and so on.

FIG. 8 illustrates yet another embodiment of the present invention. Similar to FIG. 7, but comprising an FBAR detector array. Multiple FBARs 40, 80, 82, 84, and 86 may be integrated on the same silicon, each of the FBAR resonators 80, 82, 84, and 86 may be coated with a different chemical detection layer 81, 83, 85, and 87, for detecting different chemical species. The remaining FBAR resonator 40 may be left uncoated to again act as a reference. A specie might cause several resonators to shift frequency, the relative frequency shift magnitude can provide a unique signature of the specie. A switching multiplexer 89 may be used to gather signal information from each resonator sequentially. Again, these signals are combined at combiner 70, passed through a low-pass filter 72 and the resultant differential signal (f0-fn) counted at frequency counter 76 to detect changes. For specific applications, the multiplexer may be programmed to collect data from selected subset of FBARs 80, 82, 84, and 86.

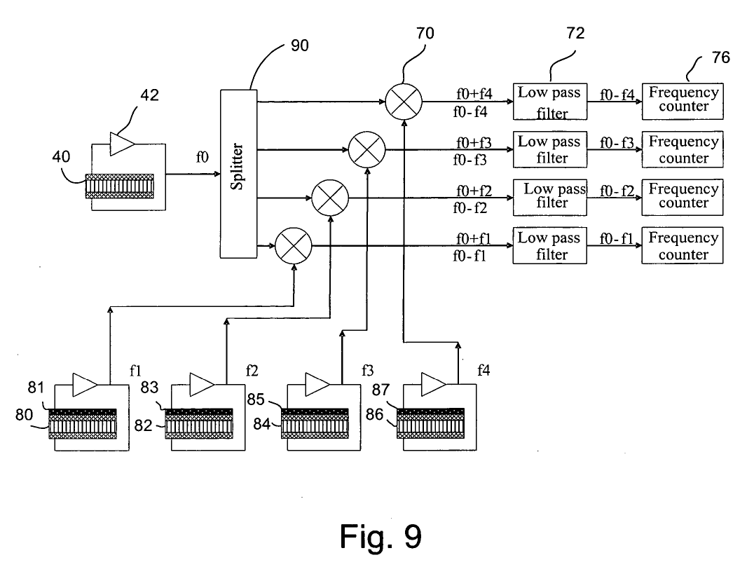

FIG. 9 shows yet another embodiment of the present invention similar to that shown in FIG. 8. The difference being that the signals f1-f4 from the coated FBAR resonators 80, 82, 84, and 86 are not multiplexed but separately combined at combiners 70 with the reference signal f0 from the uncoated FBAR resonator 40 which is split by signal splitter 90. Again, each of the combined signals are passed through separate low-pass filters 72 and the resultant differential signal counted by dedicated frequency counters 76 to detect changes indicating the presence of targeted chemicals.

Alternatively, surface-acoustic-wave (SAW) or cantilever type resonators may be used for miniaturized chemical detectors. However, the sensitivity of SAW is limited by the fact that its frequency shift with mass loading is a secondary effect; the cantilever resonator (and its derivative such as a mechanical resonating membrane) suffers from air damping effect and therefore low Q and low sensitivity. The FBAR resonators described herein are very sensitive to air damping effect but insensitive to air damping. Further, FBAR has much smaller insertion loss (IL) than SAW. Also, FBAR is fabricated on silicon, therefore can be easily integrated with other silicon devices.

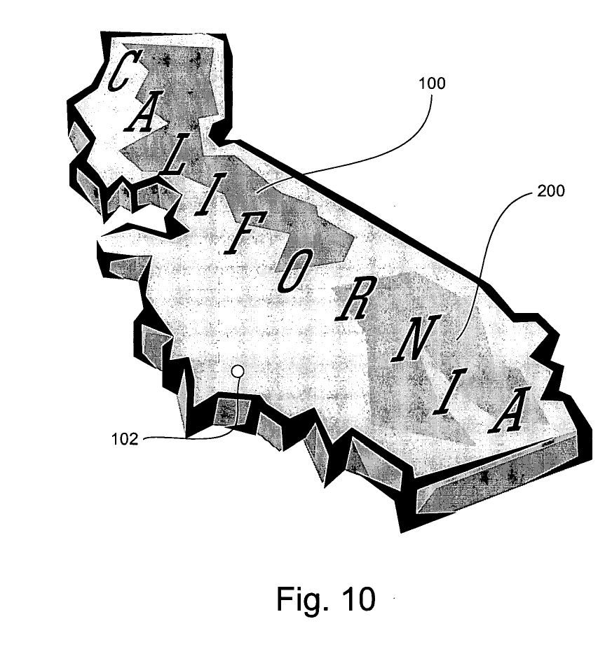

As illustrated in FIG. 10, for example, if a chemical sensor is integrated in a cell phone (PDA), or a watch, or a car with wireless connection and GPS, and such devices are widely populated, then a sensor network may be established. Consequently, a national toxicity map can be generated in real time. FIG. 10 illustrates what a toxicity map may look like for the state of California. For examples wireless consumer devices used by people in various geographic regions may report chemical detection to a central facility 102 to map the spread of various air born chemicals 100 and 200. Detailed chemical information may be obtained, such as if a chemical is released by a source fixed on ground or by a moving object, or if is spread by explosives or by wind and so on.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

What is claimed is:

1. An apparatus, comprising:
a first frequency bulk film acoustic resonator (FBAR) device;
a second FBAR device coated with a target chemical selective layer; and
means for determining a differential frequency output of the first FBAR device and the second FBAR device to determine the presence of the target chemical.

2. The apparatus as recited in claim 1 wherein the first FBAR device and the second FBAR device each comprise:
an amplifier; and
a feedback loop having an FBAR connected between the amplifier output and amplifier input.

3. The apparatus as recited in claim 1 further comprising:
a wireless device for transmitting data indicating the presence of the target chemical to a remote location to generate a toxicity map for a region.

4. The apparatus as recited in claim 1 further comprising:
a plurality of the second FBAR devices coated each coated with a target chemical selective layer to detect a different chemical.

5. The apparatus as recited in claim 1, wherein the means for means for determining a differential frequency output of the first FBAR device and the second FBAR device comprises:
a combiner to receive an output signal from the first FBAR device and the second FBAR device to output a combined signal;
a low-pass filter to receive the combined signal and output a differential output signal; and
a frequency counter to determine the differential frequency.

6. The apparatus as recited in claim 1, wherein the means for means for determining a differential frequency output of the first FBAR device and the second FBAR device comprises:
a multiplexer to multiplex signals from a plurality of the second FBAR devices;
a combiner to receive an output signal from the first FBAR device and the multiplexer to output a combined signal;
a low-pass filter to receive the combined signal and output a differential output signal; and
a frequency counter to determine the differential frequency.

7. The apparatus as recited in claim 1, wherein the means for means for determining a differential frequency output of the first FBAR device and the second FBAR device comprises:
a splitter for splitting the output the first FBAR device;
a plurality of combiners each to receive a signal from the splitter and a signal from each of a plurality of the second FBAR devices, each combiner to output a combined signal;
a plurality of low-pass filters each connected to one of the combiners; and
a plurality of frequency counters each to determine a differential frequency.

8. A method, comprising:
coating a frequency bulk film acoustic resonator (FBAR) in an FBAR oscillator with a target chemical selective layer;
determining a differential frequency between the coated FBAR oscillator and a reference uncoated FBAR oscillator; and
determining the presence of the target chemical from the differential frequency.

9. The method as recited in claim 8 further comprising:
using a wireless device to transmit information indicating the presence of the target chemical to a remote location.

10. The method as recited in claim 9, further comprising:
placing a plurality wireless devices in consumer products distributed over a geographic region.

11. The method as recited in claim 10 further comprising:
gathering at the remote location information from the plurality of wireless devices; and
producing a toxicity map for the geographic region.

12. The method as recited in claim 8 further comprising:
coating a frequency bulk film acoustic resonator (FBAR) in a plurality of FBAR oscillators with a target chemical selective layer to target different chemicals.

13. The method as recited in claim comprising:
programming a multiplexer to select ones of plurality of FBAR oscillators.

14. A system, comprising:
a plurality of wireless devices each comprising a frequency bulk film acoustic resonator (FBAR) coated with a target chemical selective layer;
a remote receiver location for receiving information from the plurality of wireless devices indicating the presence of a target chemical in locations of the plurality of wireless devices.

15. The system as recited in claim 14, wherein the information is used to generate a toxicity map.

16. The system as recited in claim 14 wherein the plurality of wireless devices comprise positioning systems.

17. The system as recited in claim 16, wherein the plurality of wireless devices comprise cell phones.

18. The system as recited in claim 16 wherein the plurality of wireless devices comprise personal digital assistants.

19. The system as recited in claim 14 wherein ones of the plurality of wireless devices comprise arrays of FBAR devices each comprising a different target chemical selective layer.
